(19) United States
(12) Patent Application Publication
(10) Pub. No.: US 2023/0149836 A1
(43) Pub. Date: May 18, 2023

(54) Regenerative Media Filter Cleaning Apparatus and Method

(71) Applicant: NEPTUNE BENSON, INC., Coventry, RI (US)

(72) Inventors: Steven J. Hawksley, Warwick (US); Paul R. Herman, Burlington, MA (US)

(21) Appl. No.: 17/427,643

(22) PCT Filed: Oct. 18, 2019
(86) PCT No.: PCT/US2019/056850

§ 371 Date: Oct. 11, 2022

Related U.S. Application Data
(60) Provisional application No. 62/799,067, filed on Jan. 31, 2019.

(51) Int. Cl. B01D 24/46; B01D 24/04; B01D 24/16; B01D 24/48; B01D 37/04; B01D 37/02; B01D 35/143; C02F 1/00

(52) U.S. Cl. CPC B01D 24/4642; B01D 24/04; B01D 24/167; B01D 24/4884; B01D 37/046; B01D 37/02; B01D 35/143; C02F 1/004; B01D 24/4861; B01D 37/043; B01D 2201/54; C02F 2303/16; C02F 2103/42

(57) ABSTRACT

A method of filtering water in a system comprising a regenerative media filter is disclosed. The method includes operating the system in a filtration mode, operating the system in a cleaning mode responsive to a differential pressure measurement across the regenerative media filter, and operating the system in a pre-filtration mode after operating the system in the cleaning mode. A water filtration system is also disclosed. The water filtration system includes a regenerative media filter vessel, a pressure sensor subsystem, a filtrate line, a feed line, a recirculation line, a plurality of valves, at least one pump, and a controller. The controller is configured to direct the water through the system. A method of facilitating filtration of aquatic or recreational facilities water is also disclosed. The method includes providing a water filtration system and providing a controller.

### CROSS-REFERENCE TO RELATED APPLICATIONS

This application claims priority under 35 U.S.C. § 119(e) to U.S. Provisional Application Ser. No. 62/799,067, titled “Regenerative Media Filter Cleaning Apparatus and Method” filed Jan. 31, 2019, which is incorporated herein by reference in its entirety for all purposes.

### FIELD OF TECHNOLOGY

Aspects and embodiments disclosed herein are generally directed to water treatment systems, and more specifically, to water treatment systems for use in aquatics or recreational facilities and methods of operating same.

### SUMMARY

In accordance with one aspect, there is provided a method of filtering water in a system comprising a regenerative media filter. The method may comprise operating the system in a filtration mode. The filtration mode may comprise opening a feed valve configured to allow passage of water to be filtered into the system, opening an end use valve configured to allow passage of filtered water out of the system, and directing the water in a first direction through the regenerative media filter to filter the water by contact with a particulate media and a plurality of tube elements for a first period of time until a differential pressure across the regenerative media filter is within a first predetermined differential pressure range which in some cases can be associated with deteriorated operation of the regenerative media filter.

The method may comprise operating the system in a cleaning mode responsive to the differential pressure being within the first predetermined differential pressure range. The cleaning mode may comprise closing the feed valve, closing the end use valve, opening at least one recirculation valve configured to allow passage of the filtered water through a recirculation line of the system, and directing the filtered water through the regenerative media filter in a second direction, opposite the first direction, configured to suspend the particulate media in the filtered water for a second period of time sufficient to decrease the differential pressure across the regenerative media filter to be within a second predetermined differential pressure range which in some cases can be associated with restored operation of the regenerative media filter.

The method may comprise operating the system in a pre-filtration mode after the second period of time. The pre-filtration mode may comprise reversing the filtered water through the regenerative media filter in the first direction for a third period of time sufficient to coat the plurality of tube elements with the particulate media. The method may comprise operating the system in the filtration mode after the third period of time.

The method may comprise measuring the differential pressure across the regenerative media filter in at least one of the filtration mode and the cleaning mode.

The first predetermined differential pressure range may be between about 10 psi and about 15 psi.

The second predetermined differential pressure range may be between about 5 psi and about 10 psi.

The second period of time may be less than about 1.5 minutes.

In some embodiments, the method may further comprise operating the system in a drain mode responsive to the first period of time trending downward. The drain mode may comprise opening a drain valve.

In some embodiments, operating the system in the filtration mode after the third period of time may comprise directing the water in the first direction for a fourth period of time until the differential pressure across the regenerative media filter is within the first predetermined differential pressure range. The method may further comprise operating the system in a drain mode responsive to the fourth period of time being less than 25% of the first period of time.

In some embodiments, the method may further comprise informing a user or service provider of a status of the water, the particulate media, and the contaminants within the regenerative media filter.

The method may comprise storing data associated with historic values of at least one of the first period of time, the second period of time, the third period of time, a measured differential pressure, flow rate, and the status of the water, the particulate media, and the contaminants within the regenerative media filter.

The method may further comprise replacing the particulate media after operating the system in the drain mode.

The method may further comprise replacing the particulate media responsive to operation of the system in the filtration mode after the third period of time comprising directing the water in the first direction until the differential pressure is within the first predetermined differential pressure range being a period of time less than 50% of the first period of time.

The method may further comprise measuring a flow rate of the water through the regenerative media filter in the filtration mode.

The method may further comprise replacing the particulate media responsive to the measured flow rate during operation of the system in the filtration mode after the third period of time being lower than a predetermined threshold flow rate.

In accordance with another aspect, there is provided a water filtration system. The water filtration system may comprise a regenerative media filter vessel having an inlet fluidly connectable to a feed source comprising water to be filtered, a first outlet fluidly connectable to an end use configured to receive filtered water, and a second outlet fluidly connectable to a drain, the regenerative media filter vessel housing a tube sheet comprising a plurality of tube elements and a particulate media.

The water filtration system may comprise a pressure sensor subsystem comprising an inlet pressure sensor and an outlet pressure sensor. The pressure sensor subsystem may be configured to measure a differential pressure across the regenerative media filter vessel. The water filtration system may comprise a filtrate line having an inlet fluidly connected to the first outlet of the regenerative media filter vessel and an outlet fluidly connectable to the end use. The water filtration system may comprise a feed line having an inlet fluidly connectable to the feed source and an outlet fluidly connected to the inlet of the regenerative media filter vessel. The water filtration system may comprise a recirculation line having an inlet and an outlet fluidly connected to the regenerative media filter vessel.

The water filtration system may comprise an end use valve positioned on the filtrate line and configured to allow passage of the filtered water to the end use. The water filtration system may comprise a feed valve positioned on the feed line and configured to allow passage of the water to the regenerative media filter vessel. The water filtration system may comprise at least one recirculation valve positioned on the recirculation line and configured to allow passage of at least one of the water and the filtered water through the recirculation line. The water filtration system may comprise at least one pump configured to direct the water though the water filtration system.

The water filtration system may comprise a controller operably connected to the pressure sensor subsystem, the end use valve, the feed valve, and the at least one recirculation valve. The controller may be configured to direct the water through the regenerative media filter vessel in a first direction for operation in a filtration mode for a first period of time until the pressure sensor subsystem measures the differential pressure in a first predetermined differential pressure range which in some cases can be associated with deteriorated operation of the regenerative media filter vessel. The controller may be configured to direct the filtered water through the regenerative media filter vessel in a second direction, opposite the first direction, for reverse recirculation in a cleaning mode responsive to the pressure sensor measuring the differential pressure in the first predetermined differential pressure range for a second period of time sufficient to decrease the differential pressure to be within a second predetermined differential pressure range which in some cases can be associated with restored operation of the regenerative media filter vessel.

In some embodiments, the controller may be configured to open the end use valve and the feed valve and close the at least one recirculation valve during operation in the filtration mode. The controller may be configured to close the end use valve and the feed valve and open the at least one recirculation valve during reverse recirculation in the cleaning mode.

In some embodiments, the controller may be configured to direct the water through the regenerative media filter vessel in the first direction for recirculation in a pre-filtration mode. The controller may be configured to close the end use valve and the feed valve and open the at least one recirculation valve during the pre-filtration mode.

The controller may be configured to direct the water for recirculation in the pre-filtration mode prior to directing the water for operation in the filtration mode.

In some embodiments, the first predetermined differential pressure range is between about 10 psi and about 15 psi. The second predetermined differential pressure range may be between about 5 psi and about 10 psi.

The controller may comprise a memory storage device configured to store data associated with historic values of the measured differential pressure.

The controller may be electrically connectable to a cloud-based memory storage configured to process and store data associated with historic values of the measured differential pressure.

The cloud-based memory storage may be configured to inform a user or service provider of a status of the water filtration system.

The cloud-based memory storage may be configured to alert the user or the service provider of the status of the water filtration system responsive to the first period of time trending downward.

The controller may be operably connected to a drain valve and configured to open the drain valve responsive to the first period of time trending downward.

In accordance with another aspect, there is provided a method of facilitating filtration of aquatic or recreational facilities water. The method may comprise providing a water filtration system. The water filtration system may comprise a regenerative media filter vessel having an inlet, a first outlet, and a second outlet, the regenerative media filter vessel housing a tube sheet comprising a plurality of tube elements and a particulate media; a pressure sensor subsystem comprising an inlet pressure sensor and an outlet pressure sensor, configured to measure a differential pressure across the regenerative media filter vessel; a filtrate line having an inlet fluidly connected to the first outlet of the regenerative media filter vessel and an outlet; a feed line having an outlet fluidly connected to the inlet of the regenerative media filter vessel and an inlet; a recirculation line having an inlet and an outlet fluidly connected to the regenerative media filter vessel; an end use valve positioned on the filtrate line; a feed valve positioned on the feed line; at least one recirculation valve positioned on the recirculation line; and at least one pump configured to direct aquatic or recreational facilities water through the regenerative media filter vessel.

The method may comprise providing a controller operably connected to the pressure sensor subsystem, the end use valve, the feed valve, and the at least one recirculation valve. The controller may be programmed to direct the aquatic or recreational facilities water and filtered water through the regenerative media filter vessel responsive to a measurement obtained from the pressure sensor subsystem. The method may comprise instructing a user to fluidly connect the first inlet of the feed line to a feed source comprising the aquatic or recreational facilities water. The method may comprise instructing a user to fluidly connect the first outlet of the filtrate line to an end use configured to receive the filtered water. The method may comprise instructing a user to establish a connection between the controller and a user interface.

In some embodiments, the method may comprise providing the particulate media.

In some embodiments, the method may comprise programming the controller to direct the aquatic or recreational facilities water and filtered water through the regenerative media filter vessel responsive to a measurement obtained from the pressure sensor subsystem.

The method may further comprise instructing the user to establish the connection between the controller and the pressure sensor subsystem, the end use valve, the feed valve, and the at least one recirculation valve.

In some embodiments, the feed source may be the end use.

The method may comprise instructing the user to establish a connection between the controller and a cloud-based memory storage configured to process and store data associated with historic values of the measured differential pressure.

The method may further comprise programming the cloud-based memory storage to inform a user or service provider of a status of the water filtration system.

In some embodiments, the cloud-based memory storage may be configured to alert a user or service provider of a need to replace the particulate media. The method may further comprise providing the particulate media responsive to the alert.

In some embodiments, the method may comprise instructing a user to select at least one value for the controller program comprising a threshold pressure differential and an elapsed period of time.

In accordance with another aspect, there is provided a non-transitory computer-readable medium having computer-readable signals stored thereon that define instruction, that, as a result of being executed by a controller, instruct the controller to perform a method of operating a water filtration system comprising acts of receiving an input signal representative of at least one of a differential pressure value and a flow rate value across a regenerative media filter, and generating an output signal configured to actuate a plurality of valves responsive to the input signal. The output signal may be configured to direct water through the regenerative media filter in a first direction for filtration for a first period of time until the differential pressure value is within a first predetermined differential pressure range, and responsive to the differential pressure value being in the first predetermined differential pressure range, direct filtered water through the regenerative media filter in a second direction, opposite the first direction, for reverse recirculation for a second period of time sufficient to decrease the differential pressure to be within a second predetermined differential pressure range.

In some embodiments, the method of operating the water filtration system may further comprise acts of generating an output signal configured to alert a user or service provider of a status of the system, responsive to the first period of time trending downward.

In some embodiments, the output signal may further be configured to drain the regenerative media filter responsive to the first period of time trending downward.

The output signal may further be configured to, after the second period of time, direct the filtered water through the regenerative media filter in the first direction for recirculation for a third period of time sufficient to coat a structure within the regenerative media filter with a particulate media.

The output signal may further be configured to, after the third period of time, direct the water through the regenerative media filter in the first direction, for filtration for a fourth period of time until the differential pressure value is within the first predetermined differential pressure range.

In some embodiments, the method of operating the water filtration system may further comprise acts of generating an output signal configured to alert a user or service provider of a status of the system responsive to the fourth period of time being less than 25% of the first period of time.

In some embodiments, the method of operating the water filtration system may further comprise acts of generating an output signal configured to alert a user or service provider of a status of the system responsive to the fourth period of time being 50% less than the first period of time.

The output signal may further be configured to drain the regenerative media filter after the fourth period of time.

In accordance with another aspect, there is provided a controller for a water filtration system. The water filtration system may comprise a regenerative media filter vessel having an inlet fluidly connectable to a feed source and an outlet fluidly connectable to an end use, the regenerative media filter vessel housing a tube sheet comprising a plurality of tube elements and a particulate media. The controller may be operably connectable to an input sensor comprising at least one of a pressure sensor subsystem and a flow meter, the input sensor configured to generate an input set of values associated with at least one of a differential pressure and a flow rate across the regenerative media filter vessel. The controller may be operably connectable to an output device comprising a plurality of valves configured to be actuated responsive to an output set of set of values generated by the controller.

The controller may comprise a system processor coupled to a memory device storing data from the input set of values. The controller may be configured to execute a decoder function configured to program the system processor to receive the data from the input set of values and provide the input set of values to the decoder function, and perform at least one calculation on the input set of values using the decoder function to generate the output set of values.

The output set of values may be configured to actuate the plurality of valves to direct water through the regenerative media filter in a first direction for filtration for a first period of time until the differential pressure value is within a first predetermined differential pressure range associated with deteriorated operation of the regenerative media filter vessel, and actuate the plurality of valves to direct filtered water through the regenerative media filter vessel in a second direction, opposite the first direction, for reverse recirculation, responsive to the differential pressure value being in the first predetermined differential pressure range, for a second period of time sufficient to decrease the differential pressure to be within a second predetermined differential pressure range associated with restored operation of the regenerative media filter vessel.

The controller may be operably connectable to a user interface configured to alert a user or service provider of a status of the system responsive to the first period of time trending downward.

The user interface may be configured to generate a user-selected set of values associated with at least one of a threshold differential pressure, a threshold flow rate, a threshold first period of time, and a threshold second period of time. The memory device may store data from the user-selected set of values. The decoder function may further be configured to program the system processor to receive the data from the user-selected set of values and provide the user-selected set of values to the decoder function to train the decoder function.

In some embodiments, the output set of values may further be configured to actuate the plurality of valves to drain the regenerative media filter vessel responsive to the first period of time trending downward.

The output set of values may further be configured to actuate the plurality of valves after the second period of time to direct the filtered water through the regenerative media filter in the first direction, for recirculation for a third period of time sufficient to coat the plurality of tube elements with the particulate media.

The output set of values may further be configured to actuate the plurality of valves after the third period of time to direct the water through the regenerative media filter in the first direction, for filtration for a fourth period of time until the differential pressure value is within the first predetermined differential pressure range.

The controller may be operably connectable to a predictive signal processor configured to generate a predictive set of values associated with a predictive signal. The predictive set of values may be configured to predict at least one of the first period of time, the second period of time, the third period of time, and the fourth period of time.

The memory device may store data from the predictive set of values. The decoder function may further be configured to program the system processor to receive the data from the predictive signal processor and provide the predictive set of values to the decoder function to train the decoder function.

In accordance with another aspect, there is provided a method of retrofitting a water filtration system. The water filtration system may comprise a regenerative media filter vessel having an inlet fluidly connectable to a feed source and an outlet fluidly connectable to an end use, the regenerative media filter vessel housing a tube sheet comprising a plurality of tube elements and a particulate media. The method may comprise providing a controller comprising a system processor coupled to a memory device storing data from an input set of values. The controller may be configured to execute a decoder function configured to program the system processor to and perform at least one calculation on the input set of values using the decoder function to generate an output set of values.

The method may comprise operably connecting the controller to an input sensor comprising at least one of a pressure sensor subsystem and a flow meter. The input sensor may be configured to generate an input set of values associated with at least one of a differential pressure and a flow rate across the regenerative media filter vessel.

The method may comprise operably connecting the controller to an output device comprising a plurality of valves configured to be actuated responsive to the output set of values generated by the controller.

The output set of values may be configured to actuate the plurality of valves to direct water through the regenerative media filter in a first direction for filtration for a first period of time until the differential pressure value is within a first predetermined differential pressure range associated with deteriorated operation of the regenerative media filter vessel, and actuate the plurality of valves to direct filtered water through the regenerative media filter vessel in a second direction, opposite the first direction, for reverse recirculation, responsive to the differential pressure value being in the first predetermined differential pressure range, for a second period of time sufficient to decrease the differential pressure to be within a second predetermined differential pressure range associated with restored operation of the regenerative media filter vessel.

In some embodiments, the method may further comprise operably connecting the controller to a user interface configured to alert a user or service provider of a status of the system responsive to the first period of time trending downward.

In some embodiments, the method may further comprise operably connecting the controller to a user interface configured to generate a user-selected set of values associated with at least one of a threshold differential pressure, a threshold flow rate, a threshold first period of time, and a threshold second period of time.

In accordance with yet another aspect, there is provided a method of operating a water filtration system. The water filtration system may comprise a regenerative media filter vessel having an inlet fluidly connectable to a feed source and an outlet fluidly connectable to an end use, the regenerative media filter vessel housing a tube sheet comprising a plurality of tube elements and a particulate media. The method may comprise obtaining a first input signal from at least one of a differential pressure sensor and a flow meter. The first input signal may comprise at least one of a differential pressure value and a flow rate value. The method may comprise acquiring a first input set of values from the first input signal.

The method may comprise obtaining a predictive signal. The predictive signal may comprise a period of time predictive signal. The method may comprise acquiring a predictive set of values from the predictive signal.

The method may comprise training a decoder function in response to data from the predictive set of values. The method may comprise performing at least one calculation on the first input set of values using the decoder function to produce an output set of values. The method may comprise operating the water filtration system with the output set of values.

The output set of values may be configured to actuate the plurality of valves to direct water through the regenerative media filter in a first direction for filtration for a first period of time until the differential pressure value is within a first predetermined differential pressure range associated with deteriorated operation of the regenerative media filter vessel, and actuate the plurality of valves to direct filtered water through the regenerative media filter vessel in a second direction, opposite the first direction, for reverse recirculation, responsive to the differential pressure value being in the first predetermined differential pressure range, for a second period of time sufficient to decrease the differential pressure to be within a second predetermined differential pressure range associated with restored operation of the regenerative media filter vessel.

The period of time predictive signal may comprise a predictive signal associated with at least one of the first period of time and the second period of time.

The method may further comprise obtaining a second input signal from a user interface, the second input signal comprising at least one of a selected threshold differential pressure, a selected threshold flow rate, a selected threshold first period of time, and a selected threshold second period of time. The method may further comprise acquiring a second input set of values from the second input signal. The method may further comprise performing at least one calculation on the second input set of values using the decoder function to produce the output set of values.

In accordance with certain aspects, the output set of values may be further configured to alert a user or service provider of a status of the system responsive to the first period of time trending downward.

The disclosure contemplates all combinations of any one or more of the foregoing aspects and/or embodiments, as well as combinations with any one or more of the embodiments set forth in the detailed description and any examples.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1A is a top view of an exemplary tube sheet, according to one embodiment;

FIG. 1B is a side perspective view of the exemplary tube sheet of FIG. 1A, according to one embodiment;

FIG. 2 is a schematic diagram of an exemplary system for water treatment, according to one embodiment;

FIG. 3 is a schematic diagram of an exemplary system for water treatment, according to one embodiment;

FIG. 4 is a schematic diagram of an exemplary system for water treatment, according to one embodiment;

FIG. 5A is a schematic diagram of the exemplary system for water treatment of FIG. 4, operating in filtration mode, according to one embodiment;

FIG. 5B is a schematic diagram of the exemplary system for water treatment of FIG. 4, operating in cleaning mode, according to one embodiment;

FIG. 5C is a schematic diagram of the exemplary system for water treatment of FIG. 4, operating in pre-filtration mode, according to one embodiment;

FIG. 5D is a schematic diagram of the exemplary system for water treatment of FIG. 4, operating in draining mode, according to one embodiment;

FIG. 6A is a flow diagram of an exemplary method for operating a water filtration system, according to one embodiment; and

FIG. 6B is a flow diagram of an exemplary method for operating a water filtration system, according to another embodiment.

### DETAILED DESCRIPTION

Systems and methods for treatment of water for use in aquatics and recreational facilities are disclosed herein. The systems and methods may provide filtration of the aquatic and/or recreational water by treatment with a media filter. Media filters typically function as particle removal filters by using a structure, for example, a porous structure, on which a medium may be coated. For example, a regenerative media filter may comprise a tube sheet containing a plurality of porous tube elements and a perlite or diatomaceous earth (DE) media.

Media filters generally employ a special grade medium to treat water. The special grade medium may be contained in a vessel or other container. The media filter may be a pressure-fed or high-rate media filter. During filtration, the water to be treated may be fed to the media filter vessel, for example, by one or more pumps. Inside the media filter vessel, the water may be distributed by a water distribution head before coming into contact with the special grade medium in the vessel. Generally, the special grade medium acts as a substrate and catches solid contaminants contained in the water. The filtered water is discarded from the vessel and may be returned to the source for further use in the aquatic or recreational facility.

In accordance with certain embodiments, the media filter may be a regenerative media filter, an activated carbon filter, or a walnut shell filter. The media filter may comprise any suitable particulate media for filtering aquatic and/or recreational water. The media filter may comprise perlite or DE media. In some embodiments, the media filter may be, for example, a Defender® media filter (distributed by Evoqua Water Technologies LLC, Pittsburgh, Pa.).

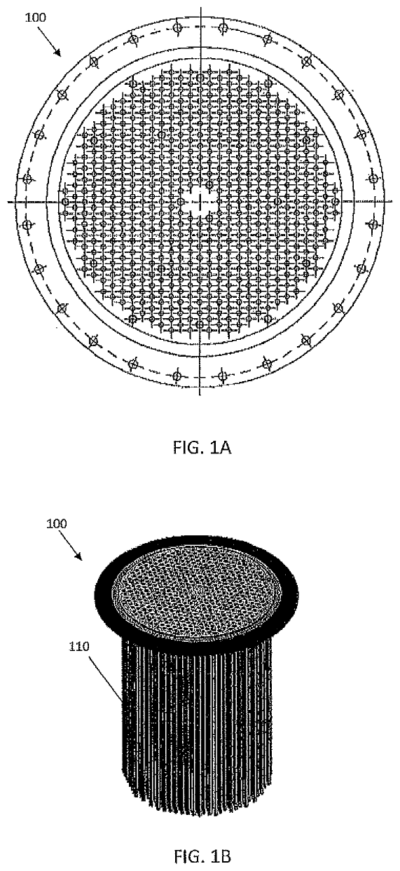

The media filter may comprise a structure coated with the media. For example, the media filter may comprise plastic tubes, optionally porous plastic tubes. A plurality of plastic tubes may be arranged on a tube sheet, for example, concentrically. FIGS. 1A and IB show exemplary tube sheet arrangements 100 comprising tube elements 110. FIG. 1A is a top view of the tube sheet 100 and FIG. 1B is a side perspective view of the tube sheet 100 showing tube elements 110.

In use, the porous tubes may be coated with perlite or DE. In such an embodiment, the porous tubes may be used to prevent the substrate from passing into the filtrate of the media filter. Once coated, the water to be treated may pass through the coating and then through the structure. The coating layer may provide for very fine filtration media, such that the media filter may filter liquids to a small particle size. In some embodiments, the media filter may be configured to filter liquids to less than 10 μm. The media filter may be configured to filter liquids to less than about 10 μm, less than about 5 μm, less than about 3 μm, or less than about 1 μm.

The media filter vessel may generally be connectable, and in use fluidly connected, to a source of the aquatic and/or recreational water. In accordance with one aspect, there is provided a system for treating water for use in aquatics or recreational facilities. The system may comprise a media filter vessel connectable to a source of water for use in aquatics or recreational facilities. The system may comprise one or more pipes, valves, or pumps positioned to distribute the water within the system and optionally to return the treated water to the aquatic or recreational facility after treatment.

In some embodiments, the aquatic and/or recreational water to be treated may include water for human or veterinary applications. For example, the aquatic or recreational water may be used for swimming. The aquatic and/or recreational water may be associated with a pool, spa, hot tub, water park, water fountain, aquarium, zoo, animal reserve, and the like. Typically, the media filter vessel may be positioned in the vicinity of the source of the aquatic and/or recreational water. In some embodiments, the media filter vessel may be remote from the source of the aquatic and/or recreational water.

While embodiments described herein generally refer to aquatic and recreational facilities water, such an application is exemplary. It should be understood that the systems and methods disclosed may be employed for filtration of any fluid to be filtered with a particulate media filter. For instance, systems and methods disclosed herein may be employed for filtration of potable water, aquaculture, irrigation, stormwater management, water for use of oil and gas processing, and other applications.

The media filter vessel may be of a size suitable for processing between 70 and 2500 gallons per minute (GPM) of water. For example, the media filter vessel may be sized to process between about 70 GPM and about 100 GPM, between about 100 GPM and about 250 GPM, between about 250 GPM and about 500 GPM, between about 500 GPM and about 1000 GPM, between about 1000 GPM and about 2000 GPM, or between about 2000 GPM and about 2500 GPM. The media filter may comprise more than one vessel, arranged in series or in parallel. Generally, the size and arrangement of media filter vessels may vary with the size of aquatic or recreational structure to be filtered.

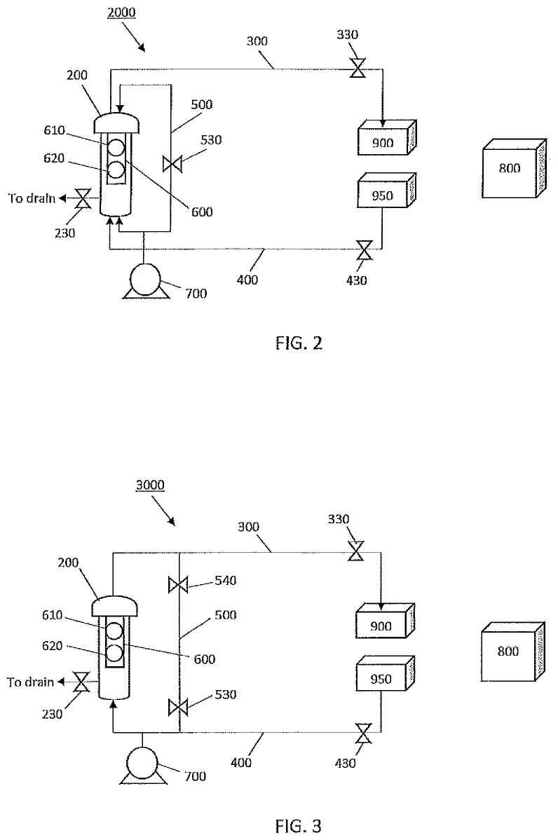

As shown in FIG. 2, an exemplary water filtration system 2000 may comprise a regenerative media filter vessel 200. The filter vessel 200 may house a tube sheet comprising a plurality of tube elements, and particulate media, as previously described. The filter vessel 200 may be fluidly connectable to a feed source 950 comprising water to be filtered and fluidly connectable to an end use 900 configured to receive filtered water. In some embodiments, the feed source 950 and the end use 900 may be the same water. For instance, the feed source 950 and the end use 900 may be an aquatic or recreational water source, for example, a pool. The filter vessel may additionally comprise a drain outlet.

The water filtration system 2000 may comprise a series of water lines. The water filtration system 2000 may have a feed line 400 fluidly connected to an inlet of the filter vessel 200 and fluidly connectable to the feed source 950. The water filtration system 2000 may comprise a filtrate line 300 fluidly connected to an outlet of the filter vessel 200 and fluidly connectable to an end use 900. The water filtration system 2000 may further comprise a recirculation line 500 extending between an outlet and an inlet of the filter vessel 200. The recirculation line 500 may be used for recirculation and reverse recirculation of the water and the filtered water through the filter vessel 200.

The water filtration system 2000 may comprise a series of valves positioned throughout the various water lines and configured to control directionality of water throughout the system 2000. The water filtration system 20000 may comprise feed valve 430 and end use valve 330 configured to allow passage of the water to the filter vessel 200 and allow passage of the filtered water to the end use 900, respectively, when opened. The water filtration system 2000 may comprise at least one recirculation valve 530 positioned on the recirculation line 500 and configured to allow passage of the water or filtered water in recirculation or reverse recirculation is through the filter vessel 200. The system 2000 may additionally comprise a drain valve 230 configured to drain the water, particulate media, and contaminants from the filter vessel 200 when open. The drained water, particulate media, and contaminants may be discarded. In some embodiments, the particulate media may be collected and regenerated for further use, for example, by a service provider.

In use, exemplary water filtration system 2000 directs water through the depicted system in a clockwise direction. As shown, the recirculation line 500 recirculates filtered water through the filter vessel 200 in a clockwise direction. Additionally, as shown, the recirculation line 500 reverse recirculates filtered water through the filter vessel 200 in a counterclockwise direction.

The system 2000 may comprise or be associated with at least one recirculation pump 700. The recirculation pump 700 may be positioned and configured to direct the water or filtered water through the system 2000. For instance, the recirculation pump 700 may be positioned and configured to direct water from an aquatic and/or recreational water source (feed source 950) to the filter vessel 200. The recirculation pump 700 may be positioned and configured to direct filtered water from the filter vessel 200 to the aquatic and/or recreational source (end use 900). The recirculation pump 700 may be positioned and configured to circulate water within the system 2000. More than one recirculation pump may be employed to effectively direct water and/or filtered water through the system 2000. The type, location, and function of the pump in non-limiting.

The system 2000 may comprise a pressure sensor subsystem 600 configured to measure the differential pressure of a liquid across the media filter vessel. The pressure sensor subsystem 600 may generally include an inlet pressure sensor 610 and an outlet pressure sensor 620. For example, the pressure sensor subsystem 600 may be configured to measure differential pressure between a liquid inlet and a liquid outlet of the media filter vessel. Accordingly, the pressure sensor subsystem 600 may be arranged as a differential pressure sensor subsystem. Any one or more of the pressure sensors may be electronic. The pressure sensors may be digital or analog. The system may comprise a flow meter positioned at an inlet or outlet of the regenerative media filter vessel 200, in addition to or in lieu of the pressure sensor subsystem 600. The flow meter may be configured to measure flow rate of the water or filtered water through the regenerative media filter vessel 200.

The system may comprise a controller 800. The controller may be operably connectable or, in use, operably connected, to at least one of the pressure sensor subsystem 600, and a valve (for example, 430, 330, 530, and 230) of the system 2000. In certain embodiments, the controller 800 may be operably connectable or connected to a pump 700. The controller 800 may be operably connectable or, in use, operably connected, to a sensor configured to measure at least one parameter of the feed source 950.

Water filtration system 3000 shown in FIG. 3 is similar to water filtration system 2000 shown in FIG. 2 except that the recirculation line 500 is fluidly connected to the feed line 400 and the filtrate line 300. The system 3000 includes additional valve 540 to direct the water or filtered water through the filter vessel 200. Valves 530 and 540 may be three-way valves positioned at the intersection of the recirculation line 500 and the feed line 400 and filtrate line 300, respectively. Valve 540 may be operably connectable or connected to controller 800, as previously described.

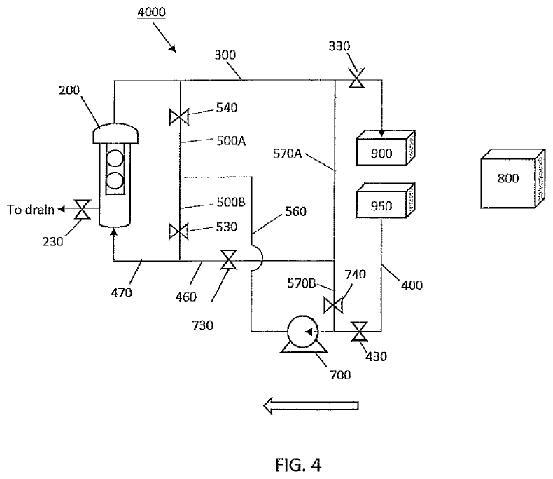

Water filtration system 4000 shown in FIG. 4 is similar to water filtration system 3000 shown in FIG. 3, except that system 4000 includes a network of recirculation lines 500 (including portions 500A and 500B), 560, and 570 (including portions 570A and 570B). In system 4000, feed line 400 is severed into portions 400, 460, 470 by intersections with recirculation lines 500, 560, 570. The network of recirculation lines 500, 560, 570 is provided to enable a single pump 700 operating in one direction, as shown by the arrow, to recirculate water and filtered water through the filter vessel 200 in both a forward and reverse direction, as directed by the controller 800. As shown, recirculation line 570 is configured to direct water toward pump 700 and recirculation line 560 is configured to direct water away from pump 700. Additional valves 730, 740 may be included to implement the directionality of the water. Valves 730, 740 may be operably connectable or connected to controller 800, as previously described.

The methods of filtering water in a system comprising the regenerative media filter disclosed herein may comprise operating the system in a filtration mode. In general, the filtration mode may include directing the water through the media filter in a first direction configured to contact the water with the particulate media and porous structure. Thus, the method may comprise opening a feed valve configured to allow passage of water to be filtered into the system and opening an end use valve configured to allow passage of the filtered water out of the system.

Periodically, the media filter may require cleaning. As contaminants such as dirt and debris build up on a surface of the porous structure, the pressure difference across the inlet and outlet of the media filter vessel typically increases. Thus, media filters are generally cleaned once the differential pressure reaches a predetermined threshold level. The methods may comprise operating the system in the filtration mode until the differential pressure across the regenerative media filter is within a first predetermined differential pressure range, associated with deteriorated operation of the regenerative media filter.

The predetermined differential pressure values may be associated with a debilitating layer cake built up on the porous structure. For instance, the predetermined threshold values may be associated with a layer cake of about ⅛ inches built up on the filter tubes. In some embodiments, the predetermined differential pressure value may be at least 5 psi, 7 psi, or 10 psi. For example, the first predetermined differential pressure range may be about 7 psi-10 psi, 10 psi-12 psi, 12 psi-15 psi, 10 psi-15 psi, or at least 15 psi.

Differential pressure may generally have an effect on flow rate. In some embodiments, the methods may comprise measuring flow rate. Flow rate may be measured in addition to measuring differential pressure or instead of measuring differential pressure. Changes in differential pressure may be determined by measured changes in flow rate. The method may comprise operating the system in the filtration mode until to a measured flow rate is within a predetermined threshold. Thus, in some embodiments, the methods may comprise measuring the flow rate of water through the regenerative media filter in the filtration mode. The flow rate may be measured and displayed or otherwise reported by a flow meter.

Health Departments typically regulate a turnover rate of water filtration in a swimming pool. For instance, Health Departments may instruct a maximum turnover rate. The methods disclosed herein may comprise operating the water filtration system to have an aquatic or recreational water turnover rate of at most 4 hours, 5 hours, 6 hours, 7 hours, or 8 hours.

Flow rate of water being filtered through the media filter may have an effect on turnover rate. In accordance with certain embodiments, the system may be operated at a flow rate of at least a threshold flow rate to provide the desired turnover rate. In such embodiments, the methods may comprise monitoring and/or controlling the flow rate. The methods may comprise operating the system in a cleaning or drain mode responsive to the flow rate being lower than a threshold flow rate.

The threshold flow rate may be calculated by the following equation:

$$F = \frac{V}{t}$$

Where:

F=threshold flow rate (gpm);

V=volume of water in swimming pool (g); and

t=maximum turnover time (min).

The method may comprise operating the system in a cleaning mode responsive to the differential pressure being within the first predetermined differential pressure range. Thus, in some embodiments, the methods may comprise measuring the differential pressure across the regenerative media filter. The differential pressure may be measured and displayed or otherwise reported by the pressure sensor subsystem. Similarly, the methods may comprise operating the system in a cleaning mode responsive to a measured flow rate being within a predetermined threshold.

A media filter comprising structures, such as Defender®, may be cleaned by expelling the media and contaminants from the structure and into suspension. The cleaning process generally allows the filter structure to receive a fresh coating layer once the coating particles reattach to the filter structure. In a regenerative media filter, the cleaning process may be performed once daily, twice daily, on alternating days, or as needed depending on the differential pressure measured across the media filter vessel. After cleaning, the structures may be recoated with media using a coating or pre-filtering process. The recoated media filter may be placed back into service.

Media and contaminants are conventionally cleaned from the structure by a pneumatic bumping process. Pneumatic bumping generally involves using compressed air and an inflatable bladder or tire. The bladder or tire may be inflated by actuation of a compressed air valve to mechanically raise and lower the filter structure coated with media and contaminants. Raising and lowering the structure forces water into the structure, evacuating the media from the surface of the structure and sending it into suspension. The suspended media settles in the filtration vessel. After pneumatic bumping, the structures may be recoated with media and placed back into service.

The pneumatic bumping mechanism is typically driven by a plurality of system components, including the inflatable bladder or tire, an air compressor, an air filter, and a mechanism for removal of moisture from the pneumatic system. Additionally, pneumatic bumping may take between 5 and 15 minutes. Occasionally, the pneumatic bumping process may be performed for 15 to 20 minutes. The systems and methods disclosed herein employ an alternative cleaning method which may be performed without the use of the pneumatic system components and in less time than the pneumatic bumping method.

Systems and methods disclosed herein may employ a hydraulic cleaning process. The hydraulic cleaning process generally employs a recirculating pump and one or more valves to functionally achieve reverse recirculation of water through the structures. The one or more valves may be actuated to open or close in a predetermined sequence to perform the hydraulic cleaning process. The hydraulic effect from the actuation sequence may evacuate the media from the structure and send it into suspension, without employing significant mechanical stress. Specifically, the hydraulic process may effectively remove media and contaminants from the structure, while eliminating the physical raising and lowering of the structure.

Thus, the methods disclosed herein may comprise operating the system in a cleaning mode. The cleaning mode may include directing the water through the media filter in a second direction, opposite the first direction. The flow of water in the second direction may be configured to suspend the particulate media in the filtered water. The cleaning mode may generally comprise closing a feed valve to block passage of water into the system and closing an end use valve to block passage of the filtered water out of the system. One or more recirculation valves may be opened to allow passage of the filtered water through a recirculation line of the system.

The system may be operated in the cleaning mode for a period of time sufficient to decrease the differential pressure across the regenerative media filter to be within a second predetermined differential pressure range associated with restored operation of the regenerative media filter. The second predetermined differential pressure values may be associated with a reduction or release of the layer cake which had built up on the porous structure. For instance, the second predetermined threshold values may be associated with a reduction of the layer cake to less than about 1/16 inches of built up on the filter tubes. The second predetermined differential pressure values may be associated with substantially no layer cake on the filter tubes. In some embodiments, the second predetermined differential pressure value may be at least 12 psi, 10 psi, 7 psi, 5 psi, 3 psi, 2 psi, or 1 psi. For example, the second predetermined differential pressure range may be about 1 psi-3 psi, 1 psi-5 psi, 5 psi-7 psi, less than 7 psi, 5 psi-10 psi, 7 psi-10 psi, less than 10 psi, 10 psi-12 psi, 12 psi-15 psi, or less than 15 psi. In certain embodiments, the second differential pressure may be at least 5 psi or at least 3 psi less than the first differential pressure.

The method may comprise operating the system in a pre filtration mode responsive to the differential pressure being within the second predetermined differential pressure range. Thus, in some embodiments, the methods may comprise measuring the differential pressure across the regenerative media filter in the cleaning mode. The differential pressure may be measured and displayed or otherwise reported by the pressure sensor subsystem.

Differential pressure may generally have an effect on flow rate. In some embodiments, the methods may comprise measuring flow rate. The method may comprise operating the system in a pre-filtration mode responsive to a measured flow rate being within a predetermined threshold. Thus, in some embodiments, the methods may comprise measuring the flow rate of water through the regenerative media filter in the cleaning mode. The flow rate may be measured and displayed or otherwise reported by a flow meter.

In other embodiments, the methods may comprise operating the system in the pre-filtration mode after the period of time sufficient to decrease the differential pressure has elapsed. The period of time may be associated with historic values of the differential pressure. The period of time may be preselected. For example, the method may comprise pre-selecting the period of time of operation in the cleaning mode and programming or setting the system to operate in accordance with the preselected period of time. In some embodiments, the period of time may be less than about 5 minutes. For instance, the period of time may be less than about 2 minutes, less than about 1.5 minutes, less than about 1 minute. The period of time may be between about 0.5-2 minutes, the period of time may be between about 40 seconds and 1.5 minutes.

The methods disclosed herein may comprise operating the system in a pre-filtration mode. The pre-filtration mode may comprise directing the water through the media filter in the first direction. The pre-filtration mode may be configured to coat the porous structure with the particulate media in preparation for the filtration mode. The pre-filtration mode may generally comprise operating the system with the same valve configuration as the cleaning mode but reversing directionality of the water through the recirculation line. Thus, during the pre-filtration mode, the feed valve may be closed to block passage of water into the system and the end use valve may be closed to block passage of the filtered water out of the system. One or more recirculation valves may be opened to allow passage of the filtered water through the recirculation line of the system.

The system may be operated in the pre-filtration mode for a period of time sufficient to coat the plurality of tube elements with the particulate media. The period of time may be between about 8-15 minutes. The period of time may be between about 8-10 minutes, 10-12 minutes, or 12-15 minutes. After coating the structure in the pre-filtration mode, the method may comprise resuming operation in the filtration mode.

In certain embodiments, the methods may comprise operating the system in the pre-filtration mode upon start-up. In such embodiments, the system may be loaded with water or feed water prior to operation in the pre-filtration mode. After the period of time sufficient to coat the structure, the method may comprise operating the system in the filtration mode, as previously described.

Periodically, the system may require draining of the regenerative media filter. During cycled use, as previously described, contaminants may build up within the media filter. The contaminants may be removed from the porous structure by operating in the cleaning mode. However, the contaminants are generally retained within the media filter vessel during and after the cleaning mode, until the media filter vessel is drained.

Thus, the methods disclosed herein may comprise operating the system in a drain mode. The drain mode may include opening a drain valve on the regenerative media filter an draining the vessel of water, particulate media, and contaminants. The drain mode may additionally comprise opening a feed valve to flush the regenerative media filter. After draining, the methods may comprise replacing the particulate media.

The methods may comprise operating the system in the drain mode responsive to the period of time of operation in the filtration mode (i.e. the period of time of operation in the filtration mode until the differential pressure across the regenerative media filter is within the first predetermined differential pressure range, associated with deteriorated operation of the regenerative media filter) trending downward. As disclosed herein, trending downward may generally refer to a period of time which is approaching a threshold value. The period of time may be estimated or expected to reach the threshold value within a predetermined period of time. In some embodiments, trending downward may refer to trending to zero or approaching zero. For instance, the period of time may be estimated or expected to reach substantially zero within a predetermined period of time.

In some embodiments, the methods may comprise operating the system in the drain mode responsive to the period of time of operation in the filtration mode being less than about 4 hours, less than about 3 hours, less than about 2 hours, less than about 1 hour, or less than about 0.5 hours from a predetermined threshold value. The methods may comprise operating the system in the drain mode responsive to the period of time of operation in the filtration mode being less than about 10 minutes, less than about 5 minutes, less than about 2 minutes, less than about 1 minute, less than about 30 seconds, less than about 10 seconds, or less than about 1 second from a predetermined threshold value. The predetermined threshold value may be the threshold value which triggers operation in the drain mode.

The methods may comprise operating the system in the drain mode responsive to the period of time of operation in the filtration mode (i.e. the period of time of operation in the filtration mode until the differential pressure across the regenerative media filter is within the first predetermined differential pressure range, associated with deteriorated operation of the regenerative media filter) being less than 50%, less than 35%, or less than 25% of the period of time of operation in a previous filtration mode. In some embodiments, operation in the previous filtration mode may refer to operation in the filtration mode immediately prior the current filtration mode. In other embodiments, operation in the previous filtration mode may refer to operation in a first filtration mode upon start-up or following a drain mode.

As previously described, the period of time of operation in the filtration mode may be determined by measuring differential pressure across the regenerative media filter and/or flow rate of water or filtered water through the regenerative media filter. Thus, in accordance with some embodiments, the methods may comprise operating the system in the drain mode responsive to the differential pressure and/or flow rate exceeding a threshold value. Similarly, the methods may comprise replacing the particulate media responsive to the differential pressure and/or flow rate exceeding a threshold value.

Exemplary systems 2000 and 3000 may reverse recirculate filtered water through recirculation line 500 by opening valves 530 and/or 540 and closing valves 330 and 430. However, in pre-filtering operation, filtered water may be recirculated in a forward direction through recirculation line 500 to effectively coat the structures with the particulate media. In filtering operation, valves 330 and 430 are typically open, while valves 530 and/or 540 are typically closed. During draining, valves 430 and 230 may be open to flush the filter vessel 200.

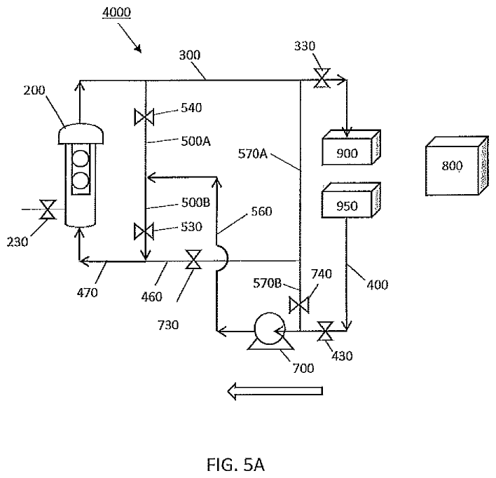

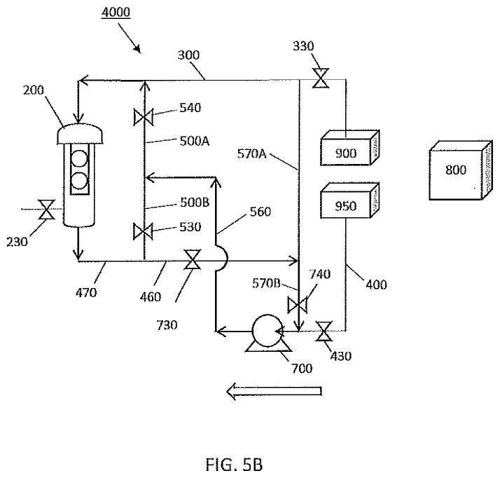

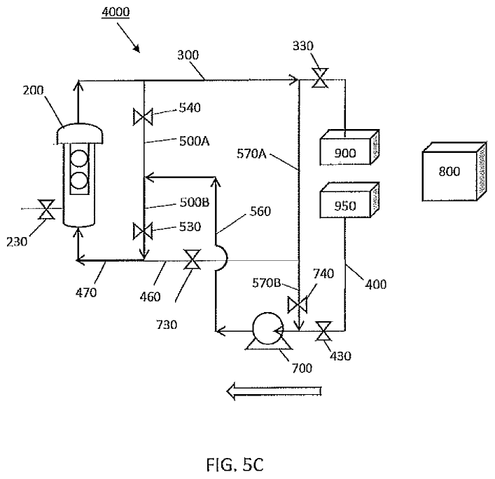

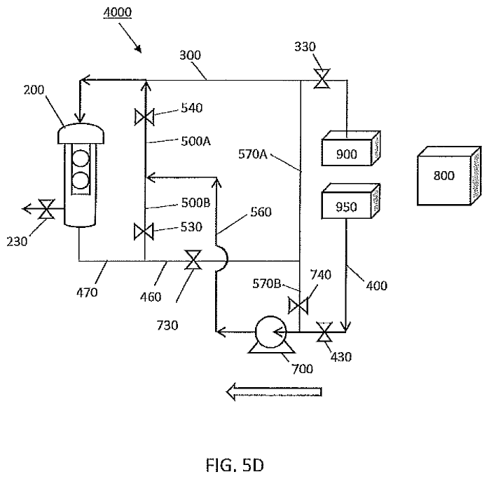

FIG. 5A is a diagram showing exemplary system 400 operating in filtration mode. Briefly, filtration system 4000 may operate in a filtration mode by opening valves 330, 430, and 530. During filtration mode, feed may enter the system through feed line 400, travel through recirculation lines 560 and 500B to feed line 470, and filtrate may be directed through filtrate line 300 to the end use.

FIG. 5B is a diagram showing exemplary system 4000 operating in cleaning mode. Briefly, valves 330, 430, and 530 may be closed, while valves 740, 730, and 540 may be open. Filtrate may be reversed through the filter vessel 200 and exit to feed line 470, continue through feed line 460, be directed to pump 700 through recirculation line 570B, and be directed to filter vessel 200 through recirculation lines 560, 500A, and filtrate line 300.

FIG. 5C is a diagram showing exemplary system 4000 operating in a pre-filtration mode. Briefly, valves 330, 430, 540, and 730 may be closed, while valves 740 and 530 may be open. Water may be circulated through the filter vessel 200 to filtrate line 300, down recirculation lines 570A and 570B to pump 700, through recirculation line 560, and through recirculation line 500B to feed line 470.

FIG. 5D is a diagram showing exemplary system 4000 operating in a drain mode. Briefly, valves 330, 530, 730, and 740 may be closed, while valves 430, 540, and 230 may be open. Feed may enter the system through feed line 400, through recirculation lines 560 and 500A to filtrate line 300, to the filter vessel 200 in an opposite flow direction. In general, the drain may comprise directing filtrate through the filter vessel with the force of gravity and out valve 230.

The embodiments described herein with respect to FIGS. 2-5D are exemplary. Other pipe, valve, and pump arrangements are within the scope of the disclosure.

The methods disclosed herein may comprise monitoring a status of the system. For instance, the methods may comprise monitoring a status of the water, the particulate media, and the contaminants within the regenerative media filter, including, for example concentration of contaminants within the regenerative media filter. The status may be monitored by storing and/or processing historic values of differential pressure across the regenerative media filter. The status may be monitored by storing and/or processing historic values of the period of time of operation in the filtration mode and cleaning mode. The status may be monitored by storing and/or processing historic values of frequency of operating the draining mode. The status may be monitored by storing and/or processing historic values of any period of time of operation of the system (for example, operation in any of the various modes described herein). The status may be monitored by storing and/or processing historic values of flow rate of water and/or filtered water through the media filter.

As the period of time of operation in the filtration mode trends to zero, operation of the draining mode approaches. Together with the draining mode, the method may comprise replacing the particulate media. The particulate media may be replaced by a user or by a service provider. Thus, as the period of time of operation in the filtration mode trends to zero, a user or service provider may be informed of the status of the system.

In certain embodiments, the method may comprise alerting a user or service provider of the need to replace the particulate media as a threshold period of time of operation in the filtration mode is reached. For instance, the method may comprise alerting a user or service provider as the period of time of operation in the filtration mode becomes less than about 30 minutes, less than about 15 minutes, less than about 10 minutes, or less than about 5 minutes.

The methods may comprise processing and storing data relating to historic values of frequency of operating in the draining mode and predicting a schedule of replacement of the particulate media. In some embodiments, the methods may comprise alerting a user or service provider of the need to replace the particulate media in about one week, about 72 hours, about 48 hours, or about 24 hours.

The methods of operating a water filtration system disclosed herein may be described with reference to input signals and output signals. The methods may comprise obtaining a first input signal from an input sensor. The first input signal may comprise at least one of a differential pressure value and a flow rate value. The methods may comprise acquiring a first input set of values from the first input signal.

The methods may comprise performing at least one calculation on the first input set of values using a decoder function to produce an output set of values. The output set of values may dictate operation of the water filter system, as previously described. For instance, the output set of values may be configured to actuate the plurality of valves to direct water through the regenerative media filter, as previously described.

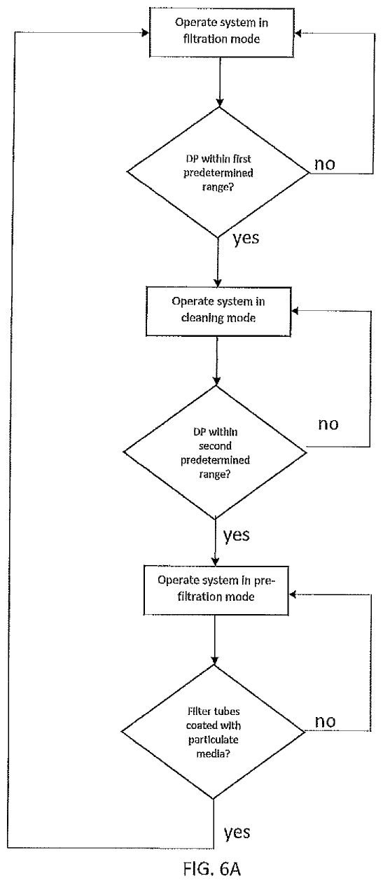

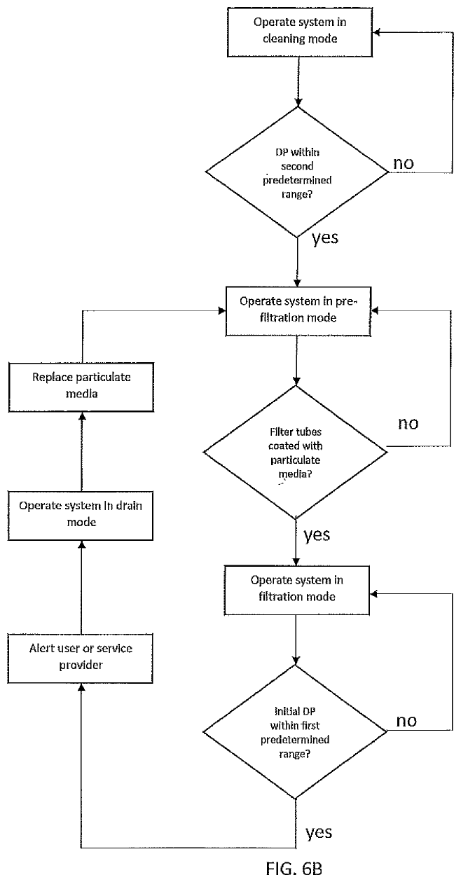

Any one or more of the methods disclosed herein may be implemented by a controller. FIG. 6A is an exemplary flow diagram showing a method of operating the water treatment system which may be implemented by the controller. Briefly, the controller may be configured to direct the water through the regenerative media filter vessel in a first direction for operation in a filtration mode for a first period of time until the pressure sensor subsystem measures the differential pressure in a first predetermined differential pressure range associated with deteriorated operation of the regenerative media filter vessel. The controller may be configured to direct the filtered water through the regenerative media filter vessel in a second direction, opposite the first direction, for reverse recirculation in a cleaning mode responsive to the pressure sensor measuring the differential pressure in the first predetermined differential pressure range for a second period of time sufficient to decrease the differential pressure to be within a second predetermined differential pressure range associated with restored operation of the regenerative media filter vessel.

In some embodiments, the controller may be configured to open the end use valve and the feed valve and close the at least one recirculation valve during operation in the filtration mode. The controller may be configured to close the end use valve and the feed valve and open the at least one recirculation valve during reverse recirculation in the cleaning mode.

In some embodiments, the controller may be configured to direct the water through the regenerative media filter vessel in the first direction for recirculation in a pre-filtration mode. The controller may be configured to close the end use valve and the feed valve and open the at least one recirculation valve during the pre-filtration mode.

In accordance with certain embodiments, the controller may comprise a memory storage device configured to store data associated with the various parameters. In some embodiments, the controller may be electrically connectable to a cloud-based memory storage configured to store data associated with the various historic values. The controller may be connectable or connected to a user interface configured to allow a user or service provider to provide input values to the controller and view output values of the controller.

In use, the controller may be operably connected to the pressure sensor subsystem. The controller may be a computer or mobile device. The controller may comprise a touch pad or other operating interface. For example, the controller may be operated through a keyboard, touch screen, track pad, and/or mouse. The controller may be configured to run software on an operating system known to one of ordinary skill in the art. The controller may be electrically connected to a power source. The controller may be digitally connected to the pressure sensor subsystem. The controller may be connected to the pressure sensor subsystem through a wireless connection. For example, the controller may be connected to the pressure sensor subsystem through wireless local area networking (WLAN) or short-wavelength ultra-high frequency (UHF) radio waves. The controller may further be operably connected to any pump or valve within the system, for example, to enable the controller to initiate or terminate the cleaning process as needed.

The controller may be programmed to direct the water or filtered water through the regenerative media filter responsive to a measurement obtained from the pressure sensor, the flow meter, or an elapsed period of time. The controller may further be programmed to direct the water or filtered water through the regenerative media filter responsive to predictive pressure differentials. The predictive pressure differentials may be generated from historic performance data.

The controller may be configured to initiate a cleaning process of the media filter vessel responsive to the differential pressure measured by the pressure sensor. In some embodiments, the controller may be configured to initiate the cleaning process at a threshold differential pressure. The threshold differential pressure may be associated with deteriorated operation of the media filter vessel. For example, the threshold differential pressure may be 5 psi, 7 psi, 10 psi, 12 psi, or 15 psi.

The controller may further be configured to initiate restored operation of the media filter vessel upon completion of the cleaning process. The controller may be configured to reinitiate filtration at a second threshold differential pressure. The second threshold differential pressure may be associated with restored operation of the media filter vessel. For example, the second threshold differential pressure may be 12 psi, 10 psi, 7 psi, 5 psi, 3 psi, 1 psi, or less than 1 psi. In general, the second threshold differential pressure is lower than the first threshold differential pressure. The second threshold differential pressure may be 1 psi, 3 psi, 5 psi, or 10 psi lower than the first threshold differential pressure.

To direct the water and filtered water through the system, and initiate the one or more modes of operation, the controller may perform at least one calculation based on input values to generate output values that instruct performance. For instance, the controller may be operably connectable to an input sensor configured to generate an input set of values and transmit the input set of values to the controller. The input sensor may include, for example, the differential pressure sensor and/or the flow meter. Additionally, the controller may be operably connectable to an output device comprising the plurality of valves. The controller may transmit an output signal to the plurality of valves to be actuated responsive to the output set of set of values generated by the controller.

To generate the output signal, the controller may comprise a system processor coupled to a memory device storing data from the input set of values. The memory device may be an internal memory device, an external memory device, or a cloud-based memory device, as previously described. The controller may be configured to execute a decoder function configured to program the system processor to receive the data from the input set of values and provide the input set of values to the decoder function, and perform at least one calculation on the input set of values using the decoder function to generate the output set of values.

The output set of values may then be configured to actuate the plurality of valves to direct the water or filtered water through the regenerative media filter, in accordance with the methods described herein.

The methods may further comprise obtaining a second input signal from a user interface, the second input signal comprising a user-selected parameter. Thus, the second input signal may comprise at least one of a selected threshold differential pressure, a selected threshold flow rate, a selected threshold first period of time, and a selected threshold second period of time. The methods may further comprise acquiring a second input set of values from the second input signal. The methods may further comprise performing at least one calculation on the second input set of values using the decoder function to produce the output set of values.

In certain embodiments, the controller may be operably connectable to a user interface. The user interface may be able to accept input signals from a user. Additionally, the user interface may be able to transmit output signals to a user. The user interface may be configured to alert a user or service provider of a status of the system responsive to the first period of time trending to zero. Thus, in some embodiments, the output set of values may be further configured to alert a user or service provider of a status of the system responsive to the first period of time trending to zero.

The user interface may be configured to generate a user-selected set of values from the input signals supplied by the user. The user-selected set of values may be associated with at least one of a threshold differential pressure, a threshold flow rate, a threshold first period of time, and a threshold second period of time. The memory device may store data from the user-selected set of values. The decoder function may further be configured to program the system processor to receive the data from the user-selected set of values and provide the user-selected set of values to the decoder function to train the decoder function. Thus, the controller may be configured to operate the system in accordance with the threshold values set by the user.

In certain embodiments, the methods may comprise obtaining a predictive signal. The predictive signal may comprise a period of time predictive signal, for instance, a predictive signal associated with a period of time of operation in at least one mode of operation. The method may comprise acquiring a predictive set of values from the predictive signal and training the decoder function with data from the predictive signal.

In accordance with certain embodiments, the controller may be operably connectable to a predictive signal processor configured to generate a predictive set of values associated with a predictive signal. The predictive set of values may be configured to predict at least one period of time of operation. The memory device may store data from the predictive set of values. The decoder function may further be configured to program the system processor to receive the data from the predictive signal processor and provide the predictive set of values to the decoder function to train the decoder function.

Thus, over time the controller may recognize and/or learn trends of the method of operating a water filtration system. The controller may then instruct the system to operate in accordance with the trends of operation. The controller may additionally inform a user or service provider of the trends of operation.

In accordance with another aspect, there is provided a non-transitory computer-readable medium. The non-transitory computer-readable medium may generally have computer-readable signals stored thereon that define instruction, that, as a result of being executed by the controller, instruct the controller to perform the methods of operating a water filtration system disclosed herein.

Thus, the non-transitory computer-readable medium may instruct the controller to perform methods comprising acts of receiving an input signal associated with a status of the system (for example, differential pressure or flow rate) and generating an output signal configured to operate the system (for example, actuate the plurality of system valves), as previously described.

In some embodiments, non-transitory computer-readable medium may instruct the controller to perform methods comprising acts of generating an output signal configured to alert a user or service provider of a status of the system, responsive to the first period of time trending to zero, as previously described. In certain embodiments, the output signal may further be configured to drain the regenerative media filter responsive to the first period of time trending to zero. The output signal may be configured to alert the user or service provider and/or drain the media filter responsive to predictive operation of the system, as previously described.

In accordance with another aspect, there is provided a method of retrofitting an existing water filtration system having a regenerative media filter.

The methods disclosed herein may comprise providing a controller, as previously described. The methods may comprise providing a controller and operably connecting the controller to an input sensor, for example, a pressure sensor subsystem and/or a flow meter. The methods may comprise operably connecting the controller to an output device, for example, the various valves. Certain methods may comprise operably connecting the controller to a pump. The methods may comprise establishing a connection between the controller and a user interface. The methods may comprise establishing a connection between the controller and a memory storage device and/or a cloud-based memory storage configured to process and store data, as previously described.

In certain embodiments, the methods may comprise programming the controller to operate the water filtration system in accordance with the methods disclosed herein. For instance, the methods may comprise programming the controller to direct water through the regenerative media filter vessel responsive to a measurement obtained from the pressure sensor subsystem being within a predetermined range, responsive to a flow rate surpassing a predetermined threshold, or responsive to an elapsed period of time.

In accordance with another aspect, there is provided a method of facilitating water filtration. The methods disclosed herein may be implemented to facilitate filtration of aquatic or recreational facilities water. The method may generally comprise providing a water filtration system, as previously described, and providing a controller, as previously described. The methods may additionally comprise instructing a user to fluidly connect the water treatment system to a feed source and end use, as previously described. For instance, the methods may comprise instructing a user to fluidly connect a feed line to the feed source and instructing a user to fluidly connect a filtrate line to an end use.

In certain embodiments, the methods may comprise instructing a user to operably connect the controller to an input sensor, for example, the pressure sensor subsystem and/or a flow meter. The methods may comprise instructing a user to operably connect the controller to an output device, for example, the valves and/or a pump. The methods may further comprise instructing a user to establish a connection between the controller and a user interface. The methods may comprise instructing a user to establish a connection between the controller and a memory storage device, for example, a cloud-based memory storage configured to process and store data, as previously described.

The methods may comprise instructing a user to provide user-selected parameters, as previously described. The user-selected parameters may comprise at least one of a threshold differential pressure, a threshold flow rate, a threshold first period of time, and a threshold second period of time. The controller may be programmed to operate responsive to the user-selected parameters.

In certain embodiments, the methods may comprise instructing a user to program the controller to operate the water filtration system in accordance with the methods disclosed herein. For instance, the methods may comprise instructing a user to program the controller to direct water through the regenerative media filter vessel responsive to a measurement obtained from the pressure sensor subsystem being within a predetermined range or responsive to an elapsed period of time.

As disclosed herein, a user may be an operator of the system, a technician of the system, a service provider, or a service customer.

The methods disclosed herein may further comprising providing the particulate media. A user or service provider may be notified of a need to replace the particulate media by the networks and methods disclosed herein. For instance, as shown in FIG. 6B, the controller or user interface may be configured to alert or inform the user or service provider of the status of the water filtration system. The controller or user interface may be configured to generate an alert that notifies the user or service provider that the period of time of operation in the filtration mode is trending to zero. In certain embodiments, the alert may be triggered by real-time measurements. In other embodiments, the alert may be triggered by predictive performance of the system. A service provider may be called to the location to replace the particulate media responsive to the alert. Thus, the methods disclosed herein may provide an automated subscription method for maintenance and replacement of the particulate media.

In certain embodiments, the methods may comprise programming the cloud-based memory storage to inform the user or service provider of the status of the water filtration system. For instance, the cloud-based memory storage may be programmed to alert the user or service provider of the need to replace the particulate media based on measured parameters or predictive performance.

The function and advantages of these and other embodiments can be better understood from the following examples. These examples are intended to be illustrative in nature and are not considered to be limiting the scope of the invention.

### Example: Water Filtration System for Swimming Pool

A Defender® system for water filtration was operated as disclosed herein to filter recreational water in a swimming pool having a water volume of 144,000 gallons. The swimming pool may be operated to have a 6-8 hour turnover rate, or as required by the Health Department. To meet the turnover rate, the filtration flow rate for the exemplary swimming pool is 300 gpm-400 gpm. The exemplary system may be operated in cleaning mode if the differential pressure is greater than 10 psi (for example, 10 psi-12 psi) or if the flow rate is below 300 gpm (a greater than 8 hour turnover rate). The exemplary system may be operated in drain mode if the differential pressure after cleaning is greater than 10 psi or if the flow rate is below 300 gpm.

The system operation log is shown in Table 1.

TABLE 1
System Operation Log and Parameters

| | | Before Cleaning | | | | | After Cleaning | | | |
|---|---|---|---|---|---|---|---|---|---|---|
| | | Flow | Inf. | Eff | | Diff. | Flow | Inf. | Eff. | Diff. |
| Day | Time | Rate | Press | Press | | Press | Rate | Press | Press | Press |
| 1 | 4:00 PM | 400 gpm | 15 psi | 13.5 | psi | 1.5 psi | 400 gpm | 15 psi | 13.5 psi | 1.5 psi |
| 5 | 7:00 AM | 300 gpm | 20 psi | 10 | psi | 10 psi | 400 gpm | 15 psi | 13.5 psi | 1.5 psi |
| 7 | 7:00 AM | 300 gpm | 20 psi | 10 | psi | 10 psi | 400 gpm | 15 psi | 13.5 psi | 1.5 psi |
| 11 | 7:00 AM | 300 gpm | 20 psi | 10 | psi | 10 psi | 400 gpm | 15 psi | 13.5 psi | 1.5 psi |
| 13 | 7:00 AM | 300 gpm | 20 psi | 10 | psi | 10 psi | 400 gpm | 15 psi | 13.5 psi | 1.5 psi |
| 14 | 11:00 AM | 300 gpm | 20 psi | 10 | psi | 10 psi | 400 gpm | 15 psi | 13.5 psi | 1.5 psi |
| 16 | 3:00 PM | 300 gpm | 20 psi | 10 | psi | 10 psi | 400 gpm | 15 psi | 13.5 psi | 1.5 psi |
| 18 | 7:00 AM | 300 gpm | 20 psi | 10 | psi | 10 psi | 400 gpm | 15 psi | 13.5 psi | 1.5 psi |
| 20 | 7:00 AM | 300 gpm | 20 psi | 10 | psi | 10 psi | 400 gpm | 15 psi | 13.5 psi | 1.5 psi |
| 22 | 7:00 AM | 300 gpm | 20 psi | 10 | psi | 10 psi | 400 gpm | 15 psi | 13.5 psi | 1.5 psi |
| 24 | 7:00 AM | 300 gpm | 20 psi | 10 | psi | 10 psi | 400 gpm | 15 psi | 13.5 psi | 1.5 psi |
| 27 | 7:00 AM | 300 gpm | 20 psi | 10 | psi | 10 psi | 400 gpm | 15 psi | 13.5 psi | 1.5 psi |
| 29 | 3:00 PM | 300 gpm | 20 psi | 10 | psi | 10 psi | 400 gpm | 15 psi | 13.5 psi | 1.5 psi |
| 33 | 3:00 PM | 300 gpm | 20 psi | 10 | psi | 10 psi | 400 gpm | 15 psi | 13.5 psi | 1.5 psi |
| 34 | 3:00 PM | 300 gpm | 20 psi | 10 | psi | 10 psi | 400 gpm | 15 psi | 13.5 psi | 1.5 psi |
| 37 | 9:50 AM | 280 gpm | 20 psi | 9 | psi | 11 psi | 400 gpm | 15.5 psi | 13 psi | 2.5 psi |
| 42 | 3:00 PM | 280 gpm | 18.5 psi | 8.5 | psi | 10.5 psi | 400 gpm | 16 psi | 13.5 psi | 2.5 psi |

As shown in the data presented in Table 1, during a typical filtration mode differential pressure increases to about 10 psi. After cleaning mode, differential pressure is decreased to 2.5 to 1.5 psi. The flow rate was maintained above 300 gpm until 37 days after start-up. Accordingly, the methods disclosed herein may be used to operate a regenerative media filter water filtration system for treatment of a 144,000 gallon swimming pool for more than 34 days in compliance with Health Department standards. The particulate media may be replaced after 34 days of operation.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure, and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

What is claimed is:

1. A method of filtering water in a system comprising a regenerative media filter, the method comprising:
operating the system in a filtration mode, comprising:
opening a feed valve configured to allow passage of water to be filtered into the system,
opening an end use valve configured to allow passage of filtered water out of the system, and
directing the water in a first direction through the regenerative media filter to filter the water by contact with a particulate media and a plurality of tube elements for a first period of time until a differential pressure across the regenerative media filter is within a first predetermined differential pressure range;
operating the system in a cleaning mode responsive to the differential pressure being within the first predetermined differential pressure range, comprising:
closing the feed valve,
closing the end use valve,
opening at least one recirculation valve configured to allow passage of water through a recirculation line of the system, and
directing the water through the regenerative media filter in a second direction, opposite the first direction, to suspend the particulate media in the filtered water for a second period of time;
operating the system in a pre-filtration mode after the second period of time, comprising: directing water through the regenerative media filter in the first direction for a third period of time to coat the plurality of tube elements with the particulate media; and
operating the system in the filtration mode after the third period of time.

2. (canceled)

3. The method of claim 1, wherein the first predetermined differential pressure range is between about 10 psi and about 15 psi.

4. The method of claim 1, wherein the second predetermined differential pressure range is between about 5 psi and about 10 psi.

5. The method of claim 1, wherein the second period of time is less than about 1.5 minutes.

6. The method of claim 1, further comprising operating the system in a drain mode responsive to the first period of time trending downward, the drain mode comprising opening a drain valve.

7. The method of claim 1, wherein operating the system in the filtration mode after the third period of time comprises directing the water in the first direction for a fourth period of time until the differential pressure across the regenerative media filter is within the first predetermined differential pressure range,
the method further comprising operating the system in a drain mode responsive to the fourth period of time being less than 25% of the first period of time.

8. The method of claim 1, further comprising informing a user or service provider of a status of the water, the particulate media, and the contaminants within the regenerative media filter.

9. (canceled)

10. (canceled)

11. The method of claim 1, further comprising replacing the particulate media responsive to operation of the system in the filtration mode after the third period of time comprising directing the water in the first direction until the differential pressure is within the first predetermined differential pressure range being a period of time less than 50% of the first period of time.

12. (canceled)

13. The method of claim 1, further comprising replacing the particulate media responsive to a measured flow rate through the regenerative media filter during operation in the filtration mode after the third period of time being lower than a predetermined threshold flow rate.

14. A water filtration system, comprising:
a regenerative media filter vessel having an inlet fluidly connectable to a feed source comprising water to be filtered, a first outlet fluidly connectable to an end use configured to receive filtered water, and a second outlet fluidly connectable to a drain, the regenerative media filter vessel housing a tube sheet comprising a plurality of tube elements configured to have particulate media on a surface thereof during operation thereof;
a pressure sensor subsystem comprising an inlet pressure sensor and an outlet pressure sensor, configured to measure a differential pressure across the regenerative media filter vessel;
a filtrate line having an inlet fluidly connected to the first outlet of the regenerative media filter vessel and an outlet fluidly connectable to the end use;
a feed line having an inlet fluidly connectable to the feed source and an outlet fluidly connected to the inlet of the regenerative media filter vessel;
a recirculation line having an inlet and an outlet fluidly connected to the regenerative media filter vessel;
an end use valve positioned on the filtrate line and configured to allow passage of the filtered water to the end use;
a feed valve positioned on the feed line and configured to allow passage of the water to the regenerative media filter vessel;
at least one recirculation valve positioned on the recirculation line and configured to allow passage of at least one of the water and the filtered water through the recirculation line;
at least one pump configured to direct the water through the water filtration system; and
a controller operably connected to the pressure sensor subsystem, the end use valve, the feed valve, and the at least one recirculation valve, the controller configured energize the at least one pump and respectively actuate the end use valve, the feed valve, and the at least one recirculation valve to:
direct the water through the regenerative media filter vessel in a first direction for operation in a filtration mode for a first period of time until the pressure sensor subsystem measures the differential pressure in a first predetermined differential pressure range, and direct the filtered water through the regenerative media filter vessel in a second direction, opposite the first direction, for reverse recirculation in a cleaning mode responsive to the pressure sensor measuring the differential pressure in the first predetermined differential pressure range for a second period of time.

15. The system of claim 14, wherein the controller is further configured to:
open the end use valve and the feed valve and close the at least one recirculation valve during operation in the filtration mode, and
close the end use valve and the feed valve and open the at least one recirculation valve during reverse recirculation in the cleaning mode.

16. The system of claim 14, wherein the controller is further configured to:
direct the water through the regenerative media filter vessel in the first direction for recirculation in a pre-filtering mode, and
close the end use valve and the feed valve and open the at least one recirculation valve during the pre-filtration mode.

17. The system of claim 16, wherein the controller is configured to direct the water for recirculation in the pre-filtration mode prior to directing the water for operation in the filtration mode.

18. The system of claim 14, wherein the first predetermined differential pressure range is between about 10 psi and about 15 psi, and wherein the second predetermined differential pressure range is between about 5 psi and about 10 psi.

19. (canceled)

20. (canceled)

21. The system of claim 14, wherein the controller is electrically connectable to a cloud-based memory storage configured to process and store data associated with historic values of the measured differential pressure.

22. The system of claim 21, wherein the cloud-based memory storage is configured to inform a user or service provider of a status of the water filtration system.

23. (canceled)

24. The system of claim 14, wherein the controller is operably connected to a drain valve and configured to open the drain valve responsive to the first period of time trending downward.

25. A method of facilitating filtration of aquatic or recreational facilities water, comprising:
providing a water filtration system, comprising:
a regenerative media filter vessel having an inlet, a first outlet, and a second outlet, the regenerative media filter vessel housing a tube sheet with a plurality of tube elements,
a pressure sensor subsystem comprising an inlet pressure sensor and an outlet pressure sensor, configured to measure a differential pressure across the regenerative media filter vessel,
a filtrate line having an inlet fluidly connected to the first outlet of the regenerative media filter vessel and an outlet,
a feed line having an outlet fluidly connected to the inlet of the regenerative media filter vessel and an inlet,
a recirculation line having an inlet and an outlet fluidly connected to the regenerative media filter vessel,
an end use valve positioned on the filtrate line,
a feed valve positioned on the feed line,
at least one recirculation valve positioned on the recirculation line, and
at least one pump configured to direct aquatic or recreational facilities water through the regenerative media filter vessel,
providing a controller operably connected to the pressure sensor subsystem, the end use valve, the feed valve, and the at least one recirculation valve, and programmed to direct the aquatic or recreational facilities water and filtered water through the regenerative media filter vessel responsive to a measurement obtained from the pressure sensor sub system;
instructing a user to fluidly connect the first inlet of the feed line to a feed source comprising the aquatic or recreational facilities water;
instructing a user to fluidly connect the first outlet of the filtrate line to an end use configured to receive the filtered water; and
instructing a user to establish a connection between the controller and a user interface.

26. The method of claim 25, further comprising providing particulate media to be introduced into the regenerative media filter vessel.

27. The method of claim 25, further comprising programming the controller to direct the aquatic or recreational facilities water and filtered water through the regenerative media filter vessel responsive to a measurement obtained from the pressure sensor subsystem.

28. The method of claim 25, further comprising instructing the user to establish the connection between the controller and the pressure sensor subsystem, the end use valve, the feed valve, and the at least one recirculation valve.

29. The method of claim 25, wherein the feed source is the end use.

30. The method of claim 25, further comprising instructing the user to establish a connection between the controller and a cloud-based memory storage configured to process and store data associated with historic values of the measured differential pressure.

31. The method of claim 30, further comprising programming the cloud-based memory storage to inform a user or service provider of a status of the water filtration system.

32. The method of claim 30, wherein the cloud-based memory storage is configured to alert a user or service provider of a need to replace the particulate media, the method further comprising providing the particulate media responsive to the alert.

33. The method of claim 25, further comprising instructing a user to select at least one value for the controller program comprising a threshold pressure differential and an elapsed period of time.

34-52. (canceled)
